(19) United States
(12) Patent Application Publication
(10) Pub. No.: US 2023/0129247 A1
(43) Pub. Date: Apr. 27, 2023

(54) HIGH-BORON CAST STEEL MATERIAL RESISTING HIGH-TEMPERATURE MOLTEN ALUMINUM CORROSION-ABRASION AND PREPARATION METHOD THEREOF

(71) Applicant: SOUTH CHINA UNIVERSITY OF TECHNOLOGY, Guangzhou (CN)

(72) Inventors: Weiping CHEN, Guangzhou (CN); Zicheng LING, Guangzhou (CN); Bing LI, Guangzhou (CN); Quanli ZHU, Guangzhou (CN); Xin YANG, Guangzhou (CN)

(73) Assignee: SOUTH CHINA UNIVERSITY OF TECHNOLOGY, Guangzhou (CN)

(21) Appl. No.: 17/802,972

(22) PCT Filed: Oct. 30, 2020
(86) PCT No.: PCT/CN2020/124995

§ 371 Date: Dec. 29, 2022

(30) Foreign Application Priority Data
Feb. 29, 2020 (CN) 202010132886.0

(51) Int. Cl. C22C 38/32; C22C 33/04; C22C 38/34; C22C 38/22; C22C 38/06; C22C 38/04; C22C 38/02; C22C 38/00; C21D 6/00; C21D 1/18

(52) U.S. Cl. CPC C22C 38/32; C22C 33/04; C22C 38/34; C22C 38/22; C22C 38/06; C22C 38/04; C22C 38/02; C22C 38/002; C21D 6/002; C21D 6/005; C21D 6/008; C21D 1/18

(57) ABSTRACT

The present invention discloses a high-boron cast steel material resisting high-temperature molten aluminum corrosion-abrasion and a preparation method thereof. The material includes the following compositions (wt.%): C: 0.1 to 1, B: 1.0 to 6.5, Cr: 7.5 to 25, Mo: 0.5 to 12.5, Si: 0.5 to 3.5, Al: 0.5 to 8.5, Mn: 0.2 to 1.2, S: less than 0.05, P: less than 0.05, and a balance of Fe. The method includes the following steps: annealing an obtained casting, and conducting quenching and tempering treatment to obtain the material.

### BACKGROUND

### Technical Field

The present invention belongs to the technical field of corrosion-abrasion resistant metal materials, and in particular relates to a high-boron cast steel material resisting high-temperature molten aluminum corrosion-abrasion and a preparation method thereof.

### Description of Related Art

During smelting, forming and hot-dip aluminizing machining of aluminum and alloys thereof, parts, in contact with high-temperature molten aluminum, of crucibles, molds, liquid charging hoppers, nozzles, fixtures, degassing rotors, etc., for use, have problems of corrosion, abrasion or even failure, resulting in that the service life of a service material is shortened, and molten aluminum is polluted. A corrosion process of a part in an aluminum melt is mainly composed of the following two parts: on the one hand, a part surface in contact with the molten aluminum is continuously dissolved and diffused under the action of the molten aluminum, and a layer of corrosion product intermetallic compound is formed on the part surface; on the other hand, under working conditions, the part may also be subjected to thermal stress, phase transformation stress or scouring action of the molten aluminum, etc., and under the action of these external conditions, exfoliation of the corrosion product intermetallic compound formed on the part surface is caused very easily, which accelerates a corrosion reaction. Therefore, in the production process of aluminum and products thereof, higher requirements are put forward for such workpiece materials, which should not only have good high-temperature molten aluminum corrosion resistance, but also have good thermal fatigue resistance, thermal shock resistance and abrasion resistance.

At present, materials resisting high-temperature molten aluminum corrosion-abrasion reported at home and abroad are mainly concentrated in two categories, one is to prepare integral materials, and the other is to conduct surface treatment on heat-resistant steel, such as boronizing, nitriding, thermal ceramic phase spraying, etc. Chinese invention patent CN104593620A discloses preparation and repairing methods of a rotor resisting high-temperature molten aluminum corrosion-abrasion for molten aluminum degassing. The invention prolongs the service life of the workpiece by thermally spraying an NiAl, NiCrAl or NiCr coating on a high-strength heat-resistant steel matrix. Although the coating can improve the corrosion-abrasion resistance of the material, the preparation process is complicated, the interface defect between the coating and the matrix is inevitable, and the bonding strength is low. Once the coating is broken or exfoliated under the action of corrosion and abrasion of the molten aluminum, the molten aluminum will directly be in contact with the matrix to accelerate the corrosion and failure of the material. Chinese invention patent CN104073706A discloses a method for preparing an iron-based composite material capable of resisting high-temperature molten aluminum corrosion-abrasion, which comprehensively considers and uses the advantages of both metals and ceramics and uses a nickel-containing ceramic preform to reinforce the high-temperature molten aluminium corrosion-abrasion resistance of the iron-based composite material. The method still has the following defects that the bonding strength of an interface between the metal and the ceramic is low, the preparation process is complicated, and a ceramic precursor is exfoliated and fails during use in a cyclic corrosion-abrasion working condition. In addition, refractory alloys such as tungsten, titanium, niobium, etc. have good high-temperature molten aluminum corrosion-abrasion resistance, but the application of such materials is limited by the difficult preparation, processing and forming and high cost of this series of materials.

### SUMMARY

### Technical Problem

### Solution to Problem

### Technology Solutions

For the above problems, the present invention aims to provide a high-boron cast steel material resisting high-temperature molten aluminum corrosion-abrasion and a preparation method thereof. In the present invention, by adjusting and controlling contents of Cr, Mo, B and Al, conducting solid solution strengthening and stabilizing a matrix phase, strong stability and corrosion-resistant boride phases of different shapes and sizes are formed for synergetic enhancement, and then high-boron cast steel with certain strong toughness and excellent high-temperature molten aluminum corrosion-abrasion resistance is prepared.

The purposes of the present invention are implemented by at least one of the following technical solutions.

A high-boron cast steel material resisting high-temperature molten aluminum corrosion-abrasion provided by the present invention includes, in percentages by mass, 0.1 to 1.0 wt. % of C, 1.0 to 6.5 wt. % of B, 7.5 to 25.0 wt. %. of Cr, 0.5 to 12.5 wt. % of Mo, 0.5 to 3.5 wt. % of Si, 0.5 to 8.5 wt. % of Al, 0.2 to 1.2 wt. % of Mn, less than 0.05 wt. % of S, less than 0.05 wt. % of P, and a balance of Fe.

Further, the high-boron cast steel material resisting high-temperature molten aluminum corrosion-abrasion includes, in percentages by mass, 0.1 to 0.8 wt. % of C, 1.0 to 5.0 wt. % of B, 10.0 to 25.0 wt. %. of Cr, 0.5 to 10.0 wt. % of Mo, 0.5 to 3.5 wt. % of Si, 0.5 to 8.5 wt. % of Al, 0.2 to 1.2 wt. % of Mn, less than 0.05 wt. % of S, less than 0.05 wt. % of P, and a balance of Fe.

A method for preparing the high-boron cast steel material resisting high-temperature molten aluminum corrosion-abrasion provided by the present invention includes the following steps.

(1) Mixing industrial pure iron or low-carbon steel scrap, ferrochromium and ferromolybdenum to form a mixture, heating and melting the mixture, and then adding an aluminum bar and aluminum titanium boron into the mixture for deoxidization of the mixture to obtain a molten steel.

(2) heating the molten steel in Step (1) to 1,580° C. to 1,620° C., after compositions of the molten steel are adjusted to be qualified, adding a modifier into the molten steel, adding an aluminum bar (an addition amount of Al is 0.2 to 0.3 wt. %) into the molten steel for deoxidization of the molten steel, and conducting tapping of the molten steel to obtain a secondary deoxidized molten steel.

(3) pouring the secondary deoxidized molten steel in Step (2) into a casting mold, and cooling and solidifying the secondary deoxidized molten steel in the casting mold to obtain a casting.

(4) heating the casting in Step (3) for annealing treatment, and conducting furnace cooling on the casting; then, heating the casting for oil quenching treatment, conducting tempering treatment on the casting, and cooling the casting down to a room temperature through air cooling to obtain the high-boron cast steel material resisting high-temperature molten aluminum corrosion-abrasion.

Further, the modifier in Step (2) includes a rare earth ferrosilicon alloy and an aluminum-titanium-boron alloy; a mass of the rare earth ferrosilicon alloy is 0.3 to 0.5 wt. % of a mass of the molten steel; and a mass of the aluminum-titanium-boron alloy is 0.3 to 0.4 wt. % of the mass of the molten steel.

Further, in Step (3), a pouring temperature of the secondary deoxidized molten steel is 1,450° C. to 1,500° C.

Further, in Step (4), a temperature of the annealing treatment is 850° C. to 900° C.; and a time of the annealing treatment is 1 to 2 hours.

Further, in Step (4), a temperature of the oil quenching treatment is 900° C. to 1,200° C., and a time of the oil quenching treatment is 1 to 4 hours.

Preferably, the temperature of the oil quenching treatment is 950° C. to 1,050° C., the time of the oil quenching treatment is 1 to 2 hours, and a temperature of oil cooling is 50° C. to 80° C.

Further, in Step (4), a temperature of the tempering treatment is 350° C. to 550° C., and a time of the tempering treatment is 1 to 4 hours.

Preferably, the temperature of the tempering treatment is 350° C. to 400° C., and the time of the tempering treatment is 1 to 2 hours.

The present invention has the following principles: based on the characteristics of high chemical stability, high hardness, high abrasion resistance, high corrosion resistance, etc. of a mesh-like boride Fe₂B phase, the boride phase is introduced into a cast steel structure, and by adjusting and controlling the contents of B, Cr and Mo, high-boron steel with a certain distribution of rod-like, irregular blocky and dendritic boride structures is obtained, and has excellent high-temperature molten aluminum corrosion-abrasion resistance; by adding a certain amount of rare earth ferrosilicon alloy and aluminum-titanium-boron alloy modifiers, grains are further refined, and the toughness of the structure is improved; and by adding a certain amount of Al for solid solution in a steel matrix, the stability of the matrix is improved.

### Beneficial Effects of the Invention

### Beneficial Effects

Compared with the prior art, the present invention has the following advantages and beneficial effects.

(1) According to the high-boron cast steel material resisting high-temperature molten aluminum corrosion-abrasion prepared by the present invention, by adjusting and controlling the contents of B, Cr and Mo, high-boron steel with a certain distribution of rod-like, irregular blocky and dendritic boride structures is obtained, and has excellent high-temperature molten aluminum corrosion-abrasion resistance.

(2) The high-boron cast steel material resisting high-temperature molten aluminum corrosion-abrasion prepared by the present invention is tested by a 1,000° C. ring-block type molten aluminum corrosion-abrasion machine (the test refers to a method introduced in China Patent No.: ZL 201010526678.5), and after 30 minutes of 750° C. molten aluminum corrosion-abrasion at a load of 10 N and a rotational speed of 75 mm s⁻¹, the high-temperature molten aluminum corrosion-abrasion resistance thereof is 2.0 to 9.0 times higher than that of H13 steel, a commonly used die steel material in the industry; meanwhile, an impact toughness of the material reaches 2.5 to 8.0 J/cm².

(3) The present invention has a simple preparation process and a relatively low cost, is suitable for industrialized production, and secondly can effectively prolong the service life of parts and components, thereby improving production efficiency, and has very good technical, economic and social benefits.

### BRIEF DESCRIPTION OF THE DRAWINGS

FIG. 1 is a microstructure picture of a high-boron cast steel material resisting high-temperature molten aluminum corrosion-abrasion prepared in Embodiment 1.

FIG. 2 is a macro-morphological picture of the high-boron cast steel material resisting high-temperature molten aluminum corrosion-abrasion prepared in Embodiment 1 after high-temperature molten aluminum corrosion-abrasion.

FIG. 3 is a microstructure picture of a high-boron cast steel material resisting high-temperature molten aluminum corrosion-abrasion prepared in Embodiment 3.

FIG. 4 is a macro-morphological picture of the high-boron cast steel material resisting high-temperature molten aluminum corrosion-abrasion prepared in Embodiment 3 after high-temperature molten aluminum corrosion-abrasion.

### DESCRIPTION OF THE EMBODIMENTS

### Embodiments of the Present Invention

The specific implementation of the present invention will be further described below with in combination with examples, but the implementation and protection of the present invention are not limited thereto. It needs to be pointed out that, if there are any processes that are not described in detail below, those skilled in the art can realize or understand them with reference to the prior art. The reagents or instruments used without the manufacturer's indication are regarded as conventional products that can be purchased from the market.

Test methods for the high-temperature molten aluminum corrosion-abrasion resistance and impact toughness of a high-boron cast steel material resisting high-temperature molten aluminum corrosion-abrasion provided in the following embodiments refer to methods introduced in Patent Document ZL 201010526678.5. Specific test conditions are as follows: 30 minutes of 750° C. molten aluminum corrosion-abrasion at a load of 10 N and a rotational speed of 75 mm s⁻¹.

### Embodiment 1

A high-boron cast steel material resisting high-temperature molten aluminum corrosion-abrasion and a preparation method thereof in this embodiment specifically included the following steps.

(1) A3 steel scrap, ferrochromium, ferroboron, ferromolybdenum and ferromanganese were mixed to form a mixture and the mixture was heated for melting of the mixture, and compositions (wt. %) of molten steel were adjusted as: C: 0.5, B: 1.0, Cr: 7.5, Mo: 0.5, Si: 1.0, Al: 0.5, Mn: 0.2, S: less than 0.05, P: less than 0.05, and a balance of Fe.

(2) The molten steel was heated to 1,580° C., and after the compositions of the molten steel were adjusted to be qualified, 0.3 wt. % of a rare earth ferrosilicon alloy and 0.3 wt. % of an aluminum-titanium-boron alloy were respectively added as modifiers into the molten steel, finally 0.2 wt. % of Al was added into the molten steel for deoxidization of the molten steel, and then tapping of the molten steel was conducted.

(3) The molten steel was poured into a casting mold at a pouring temperature of 1,480° C., and the molten steel in the casting mold was cooled and solidified to obtain a casting.

(4) The casting was subjected to annealing treatment at 850° C., subjected to heat preservation for 1 hour, and subjected to furnace cooling; then, the casting was heated to 900° C., subjected to heat preservation for 2 hours, and subjected to oil quenching treatment; finally, the casting was subjected to tempering treatment at 350° C., subjected to heat preservation for 1 hour, and was cooled down to a room temperature through air cooling to obtain the high-boron cast steel material resisting high-temperature molten aluminum corrosion-abrasion.

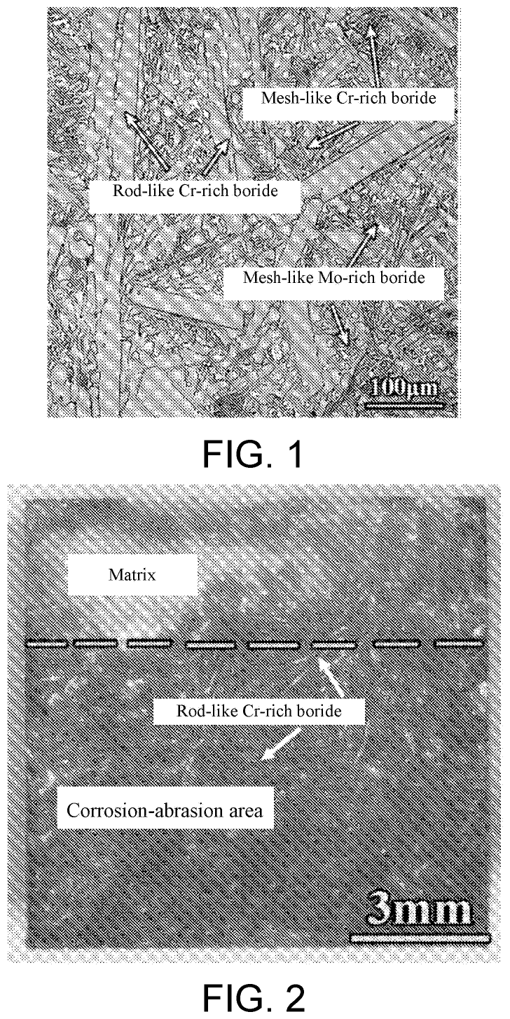

A structure of the high-boron cast steel material resisting high-temperature molten aluminum corrosion-abrasion prepared in this embodiment is shown in FIG. 1, wherein a Cr-rich boride is rod-like and mesh-like, and a Mo-rich boride phase is mainly in a mesh-like distribution. The material has excellent properties, in which a hardness of the material reaches 36.8 HRC, an impact toughness of the material reaches 8.0 J/cm², and the high-temperature molten aluminum corrosion-abrasion resistance (a mass loss of 0.79 g) of the material is 2.0 times higher than that of H13 steel (a mass loss of 2.04 g). In addition, from a surface of the material after corrosion-abrasion (as shown in FIG. 2), it can be seen that an endogenous boride is tightly embedded in a matrix and are bonded to the matrix well. When the material undergoes corrosion-abrasion in high-temperature molten aluminum, a boride with high thermal stability and good corrosion-abrasion resistance can block the corrosion of the matrix by the molten aluminum, and acts as a main bearing phase to prevent an intermetallic compound layer generated by corrosion from exfoliation, thereby slowing down the corrosion by the molten aluminum.

Embodiment 2

A high-boron cast steel material resisting high-temperature molten aluminum corrosion-abrasion and a preparation method thereof in this embodiment specifically included the following steps.

(1) Industrial pure iron, ferrochromium, ferroboron, ferromolybdenum and ferromanganese were mixed to form a mixture and the mixture was heated for melting of the mixture, and compositions (wt. %) of molten steel were adjusted as: C: 0.3, B: 2.5, Cr: 12.0, Mo: 2.5, Si: 3.5, Al: 1.0, Mn: 1.0, S: less than 0.05, P: less than 0.05, and a balance of Fe.

(2) The molten steel was heated to 1,580° C., and after the compositions of the molten steel were adjusted to be qualified, 0.3 wt. % of a rare earth ferrosilicon alloy and 0.3 wt. % of an aluminum-titanium-boron alloy were respectively added as modifiers into the molten steel, finally 0.2 wt. % of Al was added into the molten steel for deoxidization into the molten steel, and then tapping into the molten steel was conducted.

(3) The molten steel was poured into a casting mold at a pouring temperature of 1,480° C., and the molten steel in the casting mold was cooled and solidified to obtain a casting.

(4) The casting was subjected to annealing treatment at 850° C., subjected to heat preservation for 1 hour, and subjected to furnace cooling; then, the casting was heated to 900° C., subjected to heat preservation for 2 hours, and subjected to oil quenching treatment; finally, the casting was subjected to tempering treatment at 400° C., subjected to heat preservation for 1 hour, and was cooled down to a room temperature through air cooling.

In a structure of the high-boron cast steel material resisting high-temperature molten aluminum corrosion-abrasion prepared in this embodiment, a Cr-rich boride is rod-like and mesh-like, and a Mo-rich boride phase is mainly in an irregular block distribution. The material has excellent properties, in which a hardness of the material reaches 58.6 HRC, an impact toughness of the material reaches 2.5 J/cm², and the high-temperature molten aluminum corrosion-abrasion resistance of the material is 4.4 times higher than that of H13 steel. When the material undergoes corrosion-abrasion in high-temperature molten aluminum, a rod-like boride and an irregular blocky boride with high thermal stability and good corrosion-abrasion resistance can block the corrosion of a matrix by the molten aluminum, and act as main bearing phases to prevent an intermetallic compound layer generated by corrosion from exfoliation, thereby slowing down the corrosion by the molten aluminum.

### Embodiment 3

A high-boron cast steel material resisting high-temperature molten aluminum corrosion-abrasion and a preparation method thereof in this embodiment specifically included the following steps.

(1) Industrial pure iron, ferrochromium, ferroboron, ferromolybdenum and ferromanganese were mixed to form a mixture and the mixture was heated for melting of the mixture, and compositions (wt. %) of molten steel were adjusted as: C: 0.8, B: 4.2, Cr: 18.5, Mo: 8.5, Si: 0.5, Al: 4.0, Mn: 1.2, S: less than 0.05, P: less than 0.05, and a balance of Fe.

(2) The molten steel was heated to 1,580° C., and after the compositions of the molten steel were adjusted to be qualified, 0.3 wt. % of a rare earth ferrosilicon alloy and 0.3 wt. % of an aluminum-titanium-boron alloy were respectively added as modifiers into the molten steel, finally 0.2 wt. % of Al was added into the molten steel for deoxidization of the molten steel, and then tapping of the molten steel was conducted.

(3) The molten steel was poured into a casting mold at a pouring temperature of 1,480° C., and the molten steel in the casting mold was cooled and solidified to obtain a casting.

(4) The casting was subjected to annealing treatment at 850° C., subjected to heat preservation for 1 hour, and subjected to furnace cooling; then, the casting was heated to 1,000° C., subjected to heat preservation for 1 hour, and subjected to oil quenching treatment; finally, the casting was subjected to tempering treatment at 400° C., subjected to heat preservation for 1 hour, and was cooled down to a room temperature through air cooling.

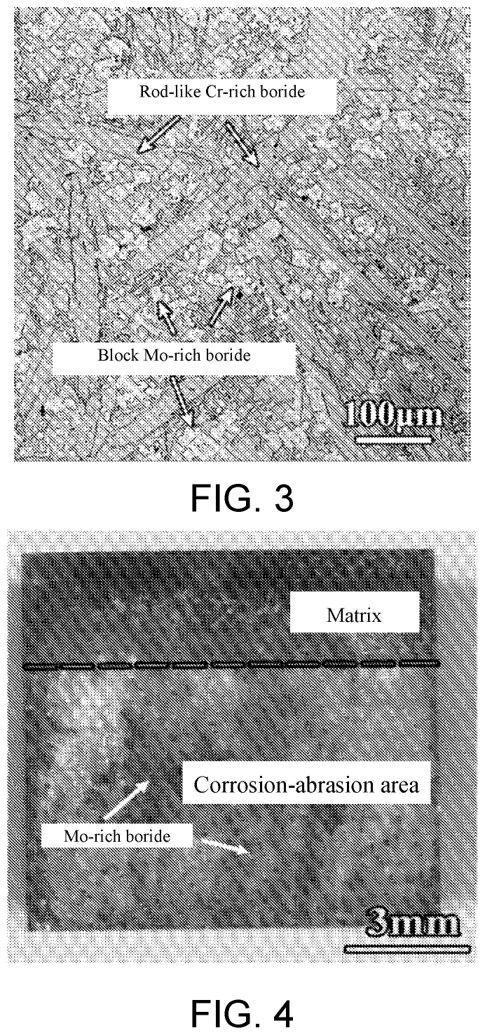

A structure of the high-boron cast steel material resisting high-temperature molten aluminum corrosion-abrasion prepared in this embodiment is shown in FIG. 3. It can be obviously seen that a Cr-rich boride is mainly in a rod-like distribution, and a Mo-rich boride phase is mainly in an irregular block distribution. The material has excellent properties, in which a hardness of the material reaches 61.0 HRC, an impact toughness of the material reaches 2.5 J/cm². In addition, a surface of the material after being subjected to high-temperature molten aluminum corrosion-abrasion (as shown in FIG. 4) is relatively smooth and has no obvious corrosion pits, and the high-temperature molten aluminum corrosion-abrasion resistance thereof is 9.0 times higher than that of H13 steel, and is excellent.

### Embodiment 4

A high-boron cast steel material resisting high-temperature molten aluminum corrosion-abrasion and a preparation method thereof in this embodiment specifically included the following steps.

(1) A3 steel scrap, ferrochromium, ferroboron, ferromolybdenum and ferromanganese were mixed to form a mixture and the mixture was heated for melting of the mixture, and compositions (wt. %) of molten steel were adjusted as: C: 0.2, B: 3.5, Cr: 25.0, Mo: 6.5, Si: 2.0, Al: 8.5, Mn: 0.6, S: less than 0.05, P: less than 0.05, and a balance of Fe.

(2) The molten steel was heated to 1,580° C., and after the compositions of the molten steel were adjusted to be qualified, 0.3 wt. % of a rare earth ferrosilicon alloy and 0.3 wt. % of an aluminum-titanium-boron alloy were respectively added as modifiers into the molten steel, finally 0.2 wt. % of Al was added into the molten steel for deoxidization of the molten steel, and then tapping of the molten steel was conducted.

(3) The molten steel was poured into a casting mold at a pouring temperature of 1,480° C., and the molten steel in the casting mold was cooled and solidified obtain a casting.

(4) The casting was subjected to annealing treatment at 850° C., subjected to heat preservation for 1 hour, and subjected to furnace cooling; then, the casting was heated to 900° C., subjected to heat preservation for 2 hours, and subjected to oil quenching treatment; finally, the casting was subjected to tempering treatment at 350° C., subjected to heat preservation for 1 hour, and was cooled down to a room temperature through air cooling.

A structure of the high-boron cast steel material resisting high-temperature molten aluminum corrosion-abrasion prepared in this embodiment is mainly composed of a martensite matrix phase, a rod-like Cr-rich boride phase and a Mo-rich boride phase in an irregular block distribution. A hardness of the material reaches 60.0 HRC, an impact toughness thereof is 2.3 J/cm², and the high-temperature molten aluminum corrosion-abrasion resistance thereof is 8.5 times higher than that of H13 steel, and is excellent.

### Embodiment 5

A high-boron cast steel material resisting high-temperature molten aluminum corrosion-abrasion and a preparation method thereof in this embodiment specifically included the following steps.

(1) Industrial pure iron, ferrochromium, ferroboron, ferromolybdenum and ferromanganese were mixed to form a mixture and the mixture was heated for melting of the mixture, and compositions (wt. %) of molten steel were adjusted as: C: 1.0, B: 6.5, Cr: 21.5, Mo: 12.5, Si: 1.5, Al: 3.5, Mn: 0.4, S: less than 0.05, P: less than 0.05, and a balance of Fe.

(2) The molten steel was heated to 1,580° C., and after the compositions of the molten steel were adjusted to be qualified, 0.3 wt. % of a rare earth ferrosilicon alloy and 0.3 wt. % of an aluminum-titanium-boron alloy were respectively added as modifiers into the molten steel, finally 0.2 wt. % of Al was added into the molten steel for deoxidization of the molten steel, and then tapping of the molten steel was conducted.

(3) The molten steel was poured into a casting mold at a pouring temperature of 1,480° C., and the molten steel in the casting mold was cooled and solidified to obtain a casting.

(4) The casting was subjected to annealing treatment at 850° C., subjected to heat preservation for 1 hour, and subjected to furnace cooling; then, the casting was heated to 900° C., subjected to heat preservation for 2 hours, and subjected to oil quenching treatment; finally, the casting was subjected to tempering treatment at 350° C., subjected to heat preservation for 1 hour, and was cooled down to a room temperature through air cooling.

A structure of the high-boron cast steel material resisting high-temperature molten aluminum corrosion-abrasion prepared in this embodiment is mainly composed of a Cr-rich boride phase in a rod-like distribution and a Mo-rich boride phase in an irregular block distribution. The material has excellent properties, a hardness thereof reaches 60.0 HRC, an impact toughness thereof reaches 4.5 J/cm², and the high-temperature molten aluminum corrosion-abrasion resistance thereof is 3.0 times higher than that of H13 steel.

The above embodiments are only preferred implementations of the present invention, and are only used to explain the present invention, but not to limit the present invention. Changes, replacements, modifications, etc. made by those skilled in the art without departing from the spiritual essence of the present invention shall belong to the scope of protection of the present invention.

1. A high-boron cast steel material resisting high-temperature molten aluminum corrosion-abrasion, comprising, in percentages by mass, 0.1 to 1.0 wt. % of C, 1.0 to 6.5 wt. % of B, 7.5 to 25.0 wt. %. of Cr, 0.5 to 12.5 wt. % of Mo, 0.5 to 3.5 wt. % of Si, 0.5 to 8.5 wt. % of Al, 0.2 to 1.2 wt. % of Mn, less than 0.05 wt. % of S, less than 0.05 wt. % of P, and a balance of Fe.

2. The high-boron cast steel material resisting high-temperature molten aluminum corrosion-abrasion according to claim 1, comprising, in percentages by mass, 0.1 to 0.8 wt. % of C, 1.0 to 5.0 wt. % of B, 10.0 to 25.0 wt. %. of Cr, 0.5 to 10.0 wt. % of Mo, 0.5 to 3.5 wt. % of Si, 0.5 to 8.5 wt. % of Al, 0.2 to 1.2 wt. % of Mn, less than 0.05 wt. % of S, less than 0.05 wt. % of P, and a balance of Fe.

3. A method for preparing the high-boron cast steel material resisting high-temperature molten aluminum corrosion-abrasion according to claim 1, comprising following steps:
step (1) mixing industrial pure iron or low-carbon steel scrap, ferrochromium and ferromolybdenum to form a mixture, heating the mixture for melting of the mixture, and then adding an aluminum bar and aluminum titanium boron into the mixture for deoxidization of the mixture to obtain a molten steel;
step (2) heating the molten steel in the step (1) to 1,580° C. to 1,620° C., then adding a modifier into the molten steel, and adding an aluminum bar into the molten steel for deoxidization of the molten steel to obtain a secondary deoxidized molten steel;
step (3) pouring the secondary deoxidized molten steel in the step (2) into a casting mold, and cooling and solidifying the secondary deoxidized molten steel in the casting mold to obtain a casting; and
step (4) heating the casting in the step (3) for annealing treatment, and conducting furnace cooling on the casting; then, heating the casting for oil quenching treatment, conducting tempering treatment on the casting, and cooling the casting down to a room temperature through air cooling to obtain the high-boron cast steel material resisting high-temperature molten aluminum corrosion-abrasion.

4. The method for preparing the high-boron cast steel material resisting high-temperature molten aluminum corrosion-abrasion according to claim 3, wherein the modifier in the step (2) comprises a rare earth ferrosilicon alloy and an aluminum-titanium-boron alloy; a mass of the rare earth ferrosilicon alloy is 0.3 to 0.5 wt. % of a mass of the molten steel; and a mass of the aluminum-titanium-boron alloy is 0.3 to 0.4 wt. % of the mass of the molten steel.

5. The method for preparing the high-boron cast steel material resisting high-temperature molten aluminum corrosion-abrasion according to claim 3, wherein in the step (3), a pouring temperature of the secondary deoxidized molten steel is 1,450° C. to 1,500° C.

6. The method for preparing the high-boron cast steel material resisting high-temperature molten aluminum corrosion-abrasion according to claim 3, wherein in the step (4), a temperature of the annealing treatment is 850° C. to 900° C.; and a time of the annealing treatment is 1 to 2 hours.

7. The method for preparing the high-boron cast steel material resisting high-temperature molten aluminum corrosion-abrasion according to claim 3, wherein in the step (4), a temperature of the oil quenching treatment is 900° C. to 1,200° C., and a time of the oil quenching treatment is 1 to 4 hours.

8. The method for preparing the high-boron cast steel material resisting high-temperature molten aluminum corrosion-abrasion according to claim 7, wherein the temperature of the oil quenching treatment is 950° C. to 1,050° C., the time of the oil quenching treatment is 1 to 2 hours, and a temperature of oil cooling is 50° C. to 80° C.

9. The method for preparing the high-boron cast steel material resisting high-temperature molten aluminum corrosion-abrasion according to claim 3, wherein in the step (4), a temperature of the tempering treatment is 350° C. to 550° C., and a time of the tempering treatment is 1 to 4 hours.

10. The method for preparing the high-boron cast steel material resisting high-temperature molten aluminum corrosion-abrasion according to claim 9, wherein the temperature of the tempering treatment is 350° C. to 400° C., and the time of the tempering treatment is 1 to 2 hours.

11. A method for preparing the high-boron cast steel material resisting high-temperature molten aluminum corrosion-abrasion according to claim 2, comprising following steps:
step (1) mixing industrial pure iron or low-carbon steel scrap, ferrochromium and ferromolybdenum to form a mixture, heating the mixture for melting of the mixture, and then adding an aluminum bar and aluminum titanium boron into the mixture for deoxidization of the mixture to obtain a molten steel;
step (2) heating the molten steel in the step (1) to 1,580° C. to 1,620° C., then adding a modifier into the molten steel, and adding an aluminum bar into the molten steel for deoxidization of the molten steel to obtain a secondary deoxidized molten steel;
step (3) pouring the secondary deoxidized molten steel in the step (2) into a casting mold, and cooling and solidifying the secondary deoxidized molten steel in the casting mold to obtain a casting; and
step (4) heating the casting in the step (3) for annealing treatment, and conducting furnace cooling on the casting; then, heating the casting for oil quenching treatment, conducting tempering treatment on the casting, and cooling the casting down to a room temperature through air cooling to obtain the high-boron cast steel material resisting high-temperature molten aluminum corrosion-abrasion.

12. The method for preparing the high-boron cast steel material resisting high-temperature molten aluminum corrosion-abrasion according to claim 11, wherein the modifier in the step (2) comprises a rare earth ferrosilicon alloy and an aluminum-titanium-boron alloy; a mass of the rare earth ferrosilicon alloy is 0.3 to 0.5 wt. % of a mass of the molten steel; and a mass of the aluminum-titanium-boron alloy is 0.3 to 0.4 wt. % of the mass of the molten steel.

13. The method for preparing the high-boron cast steel material resisting high-temperature molten aluminum corrosion-abrasion according to claim 11, wherein in the step (3), a pouring temperature of the secondary deoxidized molten steel is 1,450° C. to 1,500° C.

14. The method for preparing the high-boron cast steel material resisting high-temperature molten aluminum corrosion-abrasion according to claim 11, wherein in the step (4), a temperature of the annealing treatment is 850° C. to 900° C.; and a time of the annealing treatment is 1 to 2 hours.

15. The method for preparing the high-boron cast steel material resisting high-temperature molten aluminum corrosion-abrasion according to claim 11, wherein in the step (4), a temperature of the oil quenching treatment is 900° C. to 1,200° C., and a time of the oil quenching treatment is 1 to 4 hours.

16. The method for preparing the high-boron cast steel material resisting high-temperature molten aluminum corrosion-abrasion according to claim 15, wherein the temperature of the oil quenching treatment is 950° C. to 1,050° C., the time of the oil quenching treatment is 1 to 2 hours, and a temperature of oil cooling is 50° C. to 80° C.

17. The method for preparing the high-boron cast steel material resisting high-temperature molten aluminum corrosion-abrasion according to claim 11, wherein in the step (4), a temperature of the tempering treatment is 350° C. to 550° C., and a time of the tempering treatment is 1 to 4 hours.

18. The method for preparing the high-boron cast steel material resisting high-temperature molten aluminum corrosion-abrasion according to claim 17, wherein the temperature of the tempering treatment is 350° C. to 400° C., and the time of the tempering treatment is 1 to 2 hours.
